(19) United States
(12) Patent Application Publication
(10) Pub. No.: US 2008/0191843 A1
(43) Pub. Date: Aug. 14, 2008

(54) Scanning Settings Inferred From Prior Scan Data

(75) Inventor: Martin STRZELCZYK, New Market, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 12/029,450

(22) Filed: Feb. 11, 2008

Related U.S. Application Data
(60) Provisional application No. 60/900,316, filed on Feb. 9, 2007.

(51) Int. Cl. H04Q 5/22

(52) U.S. Cl. 340/10.1

(57) ABSTRACT

A method of managing power consumption of a radio frequency identification (RFID) reader is provided. The method includes receiving rules that describe event conditions, performing background scanning, determining whether an event has occurred based on data gathered during background scanning, and updating scanning settings of the reader if an event has occurred.

### CROSS REFERENCE TO RELATED APPLICATIONS

This application claims the benefit of U.S. Provisional Appl. No. 60/900,316, filed Feb. 9, 2007, which is incorporated by reference herein in its entirety.

### FIELD OF THE INVENTION

The present invention relates to radio frequency identification (RFID) technology.

### BACKGROUND

Radio frequency identification (RFID) tags are electronic devices that may be affixed to items whose presence is to be detected and/or monitored. The presence of an RFID tag, and therefore the presence of the item to which the tag is affixed, may be checked and monitored wirelessly by devices known as “readers” or “interrogators.” With the maturation of RFID technology, efficient communication between tags and readers has become a key enabler in supply chain management, especially in manufacturing, shipping, and retail industries, as well as in building security installations, healthcare facilities, libraries, airports, warehouses etc.

In many applications, RFID technology is used to monitor a large population of items. As the number of tags in a tag population and the area they span increases, reading each tag becomes an increasingly power intensive process. This increasing demand for power results in more complicated circuitry at the reader and/or the tag, often leading to problems during operation. Additionally, the increased demand for power results in the need for larger batteries for the reader, which is undesirable for mobile, battery powered applications.

Thus, what are needed are systems and methods for conserving power during scanning operations within a mobile reader installation.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an environment where RFID readers communicate with an exemplary population of RFID tags.

FIG. 2 shows a block diagram of receiver and transmitter portions of a RFID reader.

FIG. 3 shows a block diagram of an example RFID tag.

FIG. 4 shows an information data path in an RFID system, according to an embodiment of the present invention.

FIG. 5 shows a system for monitoring the presence of items in an RFID environment, according to embodiments of the present invention.

FIG. 6 depicts an exemplary scanning setting interface module, according to an example embodiment of the present invention.

FIGS. 7 and 8 show plots of exemplary membership functions, according to embodiments of the present invention.

FIG. 9 shows another example RFID environment, according to an embodiment of the present invention.

FIG. 10 shows a flowchart providing example steps for communicating with a population of RFID tags, according to an example embodiment of the present invention.

FIG. 11 is a block diagram of an exemplary computer system useful for implementing the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner. Likewise, particular bit values of “0” or “1” (and representative voltage values) are used in illustrative examples provided herein to represent data for purposes of illustration only. Data described herein can be represented by either bit value (and by alternative voltage values), and embodiments described herein can be configured to operate on either bit value (and any representative voltage value), as would be understood by persons skilled in the relevant art(s).

### Example RFID System Embodiment

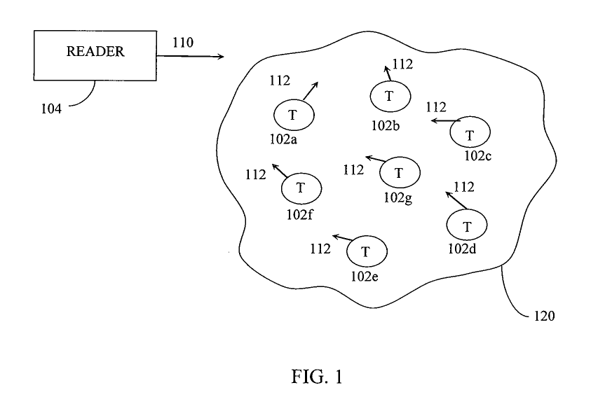

Before describing embodiments of the present invention in detail, it is helpful to describe an example RFID communications environment in which the invention may be implemented. FIG. 1 illustrates an environment 100 where a RFID tag reader 104 (also referred to as an “interrogator”) communicates with an exemplary population 120 of RFID tags 102. As shown in FIG. 1, the population 120 of tags includes seven tags 102a-102g. A population 120 may include any number of tags 102.

Environment 100 includes one or more readers 104. A reader 104 may be requested by an external application to address the population of tags 120. Alternatively, reader 104 may have internal logic that initiates communication, or may have a trigger mechanism that an operator of reader 104 uses to initiate communication.

As shown in FIG. 1, reader 104 transmits an interrogation signal 110 having a carrier frequency to the population of tags 120. Reader 104 operates in one or more of the frequency bands allotted for this type of RF communication. For example, frequency bands of 902-928 MHz and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting and absorbing portions of signal 110 according to a time-based pattern or frequency. This technique for alternatively absorbing and reflecting signal 110 is referred to herein as backscatter modulation. Readers 104 receive and obtain data from response signals 112, such as an identification number of the responding tag 102. In the embodiments described herein, a reader may be capable of communicating with tags 102 according to any suitable communication protocol, including binary traversal protocols, slotted aloha protocols, Class 0, Class 1, EPC Gen 2, any others mentioned elsewhere herein, and future communication protocols.

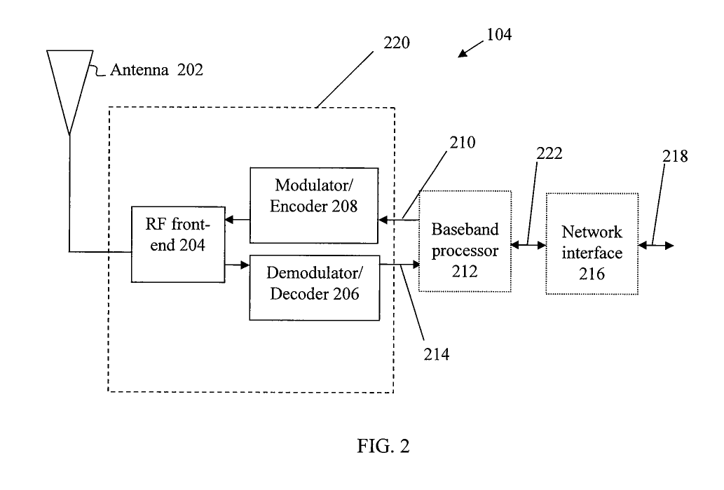

FIG. 2 shows a block diagram of an example RFID reader 104. Reader 104 includes one or more antennas 202, a receiver and transmitter portion 220 (also referred to as transceiver 220), a baseband processor 212, and a network interface 216. These components of reader 104 may include software, hardware, and/or firmware, or any combination thereof, for performing their functions.

Baseband processor 212 and network interface 216 are optionally present in reader 104. Baseband processor 212 may be present in reader 104, or may be located remote from reader 104. For example, in an embodiment, network interface 216 may be present in reader 104, to communicate between transceiver portion 220 and a remote server that includes baseband processor 212. When baseband processor 212 is present in reader 104, network interface 216 may be optionally present to communicate between baseband processor 212 and a remote server. In another embodiment, network interface 216 is not present in reader 104.

In an embodiment, reader 104 includes network interface 216 to interface reader 104 with a communications network 218. As shown in FIG. 2, baseband processor 212 and network interface 216 communicate with each other via a communication link 222. Network interface 216 is used to provide an interrogation request 210 to transceiver portion 220 (optionally through baseband processor 212), which may be received from a remote server coupled to communications network 218. Baseband processor 212 optionally processes the data of interrogation request 210 prior to being sent to transceiver portion 220. Transceiver 220 transmits the interrogation request via antenna 202.

Reader 104 has at least one antenna 202 for communicating with tags 102 and/or other readers 104. Antenna(s) 202 may be any type of reader antenna known to persons skilled in the relevant art(s), including a vertical, dipole, loop, Yagi-Uda, slot, or patch antenna type. For description of an example antenna suitable for reader 104, refer to U.S. Ser. No. 11/265,143, filed Nov. 3, 2005, titled “Low Return Loss Rugged RFID Antenna,” now pending, which is incorporated by reference herein in its entirety.

Transceiver 220 receives a tag response via antenna 202. Transceiver 220 outputs a decoded data signal 214 generated from the tag response. Network interface 216 is used to transmit decoded data signal 214 received from transceiver portion 220 (optionally through baseband processor 212) to a remote server coupled to communications network 218. Baseband processor 212 optionally processes the data of decoded data signal 214 prior to being sent over communications network 218.

In embodiments, network interface 216 enables a wired and/or wireless connection with communications network 218. For example, network interface 216 may enable a wireless local area network (WLAN) link (including a IEEE 802.11 WLAN standard link), a BLUETOOTH link, and/or other types of wireless communication links. Communications network 218 may be a local area network (LAN), a wide area network (WAN) (e.g., the Internet), and/or a personal area network (PAN).

In embodiments, a variety of mechanisms may be used to initiate an interrogation request by reader 104. For example, an interrogation request may be initiated by a remote computer system/server that communicates with reader 104 over communications network 218. Alternatively, reader 104 may include a finger-trigger mechanism, a keyboard, a graphical user interface (GUI), and/or a voice activated mechanism with which a user of reader 104 may interact to initiate an interrogation by reader 104.

In the example of FIG. 2, transceiver portion 220 includes a RF front-end 204, a demodulator/decoder 206, and a modulator/encoder 208. These components of transceiver 220 may include software, hardware, and/or firmware, or any combination thereof, for performing their functions. Example description of these components is provided as follows.

Modulator/encoder 208 receives interrogation request 210, and is coupled to an input of RF front-end 204. Modulator/encoder 208 encodes interrogation request 210 into a signal format, modulates the encoded signal, and outputs the modulated encoded interrogation signal to RF front-end 204. For example, pulse-interval encoding (PIE) may be used in a Gen 2 embodiment. Furthermore, double sideband amplitude shift keying (DSB-ASK), single sideband amplitude shift keying (SSB-ASK), or phase-reversal amplitude shift keying (PR-ASK) modulation schemes may be used in a Gen 2 embodiment. Note that in an embodiment, baseband processor 212 may alternatively perform the encoding function of modulator/encoder 208.

RF front-end 204 may include one or more antenna matching elements, amplifiers, filters, an echo-cancellation unit, a down-converter, and/or an up-converter. RF front-end 204 receives a modulated encoded interrogation signal from modulator/encoder 208, up-converts (if necessary) the interrogation signal, and transmits the interrogation signal to antenna 202 to be radiated. Furthermore, RF front-end 204 receives a tag response signal through antenna 202 and down-converts (if necessary) the response signal to a frequency range amenable to further signal processing.

Demodulator/decoder 206 is coupled to an output of RF front-end 204, receiving a modulated tag response signal from RF front-end 204. In an EPC Gen 2 protocol environment, for example, the received modulated tag response signal may have been modulated according to amplitude shift keying (ASK) or phase shift keying (PSK) modulation techniques. Demodulator/decoder 206 demodulates the tag response signal. For example, the tag response signal may include backscattered data formatted according to FM0 or Miller encoding formats in an EPC Gen 2 embodiment. Demodulator/decoder 206 outputs decoded data signal 214. Note that in an embodiment, baseband processor 212 may alternatively perform the decoding function of demodulator/decoder 206.

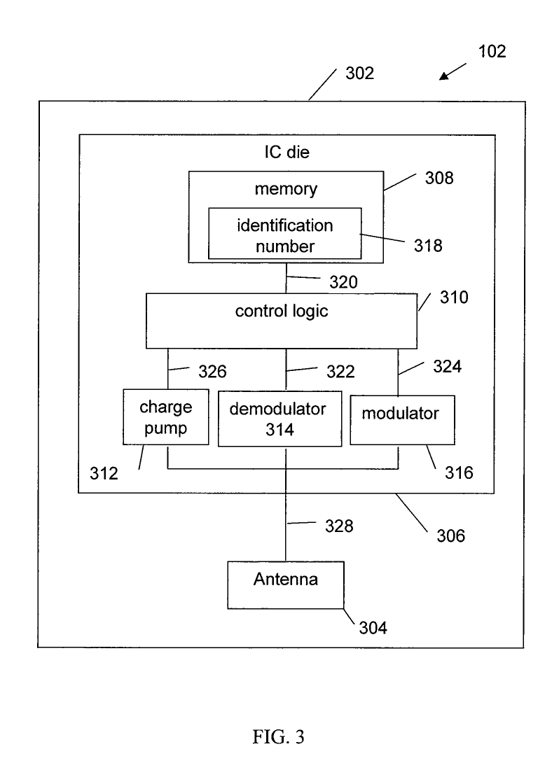

The present invention is applicable to any type of RFID tag. FIG. 3 shows a plan view of an example radio frequency identification (RFID) tag 102. Tag 102 includes a substrate 302, an antenna 304, and an integrated circuit (IC) 306. Antenna 304 is formed on a surface of substrate 302. Antenna 304 may include any number of one, two, or more separate antennas of any suitable antenna type, including dipole, loop, slot, or patch antenna type. IC 306 includes one or more integrated circuit chips/dies, and can include other electronic circuitry. IC 306 is attached to substrate 302, and is coupled to antenna 304. IC 306 may be attached to substrate 302 in a recessed and/or non-recessed location.

IC 306 controls operation of tag 102, and transmits signals to, and receives signals from RFID readers using antenna 304. In the example embodiment of FIG. 3, IC 306 includes a memory 308, a control logic 310, a charge pump 312, a demodulator 314, and a modulator 316. An input of charge pump 312, an input of demodulator 314, and an output of modulator 316 are coupled to antenna 304 by antenna signal 328. Note that in the present disclosure, the terms “lead” and “signal” may be used interchangeably to denote the connection between elements or the signal flowing on that connection.

Memory 308 is typically a non-volatile memory, but can alternatively be a volatile memory, such as a SRAM. Memory 308 stores data, including an identification number 318. Identification number 318 typically is a unique identifier (at least in a local environment) for tag 102. For instance, when tag 102 is interrogated by a reader (e.g., receives interrogation signal 110 shown in FIG. 1), tag 102 may respond with identification number 318 to identify itself. Identification number 318 may be used by a computer system to associate tag 102 with its particular associated object/item.

Demodulator 314 is coupled to antenna 304 by antenna signal 328. Demodulator 314 demodulates a radio frequency communication signal (e.g., interrogation signal 110) on antenna signal 328 received from a reader by antenna 304. Control logic 310 receives demodulated data of the radio frequency communication signal from demodulator 314 on input signal 322. Control logic 310 controls the operation of RFID tag 102, based on internal logic, the information received from demodulator 314, and the contents of memory 308. For example, control logic 310 accesses memory 308 via a bus 320 to determine whether tag 102 is to transmit a logical “1” or a logical “0” (of identification number 318) in response to a reader interrogation. Control logic 310 outputs data to be transmitted to a reader (e.g., response signal 112) onto an output signal 324. Control logic 310 may include software, firmware, and/or hardware, or any combination thereof. For example, control logic 310 may include digital circuitry, such as logic gates, and may be configured as a state machine in an embodiment.

Modulator 316 is coupled to antenna 304 by antenna signal 328, and receives output signal 324 from control logic 310. Modulator 316 modulates data of output signal 324 (e.g., one or more bits of identification number 318) onto a radio frequency signal (e.g., a carrier signal transmitted by reader 104) received via antenna 304. The modulated radio frequency signal is response signal 112, which is received by reader 104. In an embodiment, modulator 316 includes a switch, such as a single pole, single throw (SPST) switch. The switch changes the return loss of antenna 304. The return loss may be changed in any of a variety of ways. For example, the RF voltage at antenna 304 when the switch is in an “on” state may be set lower than the RF voltage at antenna 304 when the switch is in an “off” state by a predetermined percentage (e.g., 30 percent). This may be accomplished by any of a variety of methods known to persons skilled in the relevant art(s).

Modulator 316 and demodulator 314 may be referred to collectively as a “transceiver” of tag 102.

Charge pump 312 is coupled to antenna 304 by antenna signal 328. Charge pump 312 receives a radio frequency communication signal (e.g., a carrier signal transmitted by reader 104) from antenna 304, and generates a direct current (DC) voltage level that is output on a tag power signal 326. Tag power signal 326 is used to power circuits of IC die 306, including control logic 320.

In an embodiment, charge pump 312 rectifies the radio frequency communication signal of antenna signal 328 to create a voltage level. Furthermore, charge pump 312 increases the created voltage level to a level sufficient to power circuits of IC die 306. Charge pump 312 may also include a regulator to stabilize the voltage of tag power signal 326. Charge pump 312 may be configured in any suitable way known to persons skilled in the relevant art(s). For description of an example charge pump applicable to tag 102, refer to U.S. Pat. No. 6,734,797, titled “Identification Tag Utilizing Charge Pumps for Voltage Supply Generation and Data Recovery,” which is incorporated by reference herein in its entirety. Alternative circuits for generating power in a tag are also applicable to embodiments of the present invention.

It will be recognized by persons skilled in the relevant art(s) that tag 102 may include any number of modulators, demodulators, charge pumps, and antennas. Tag 102 may additionally include further elements, including an impedance matching network and/or other circuitry. Embodiments of the present invention may be implemented in tag 102, and in other types of tags.

Embodiments described herein are applicable to all forms of tags, including tag “inlays” and “labels.” A “tag inlay” or “inlay” is defined as an assembled RFID device that generally includes an integrated circuit chip (and/or other electronic circuit) and antenna formed on a substrate, and is configured to respond to interrogations. A “tag label” or “label” is generally defined as an inlay that has been attached to a pressure sensitive adhesive (PSA) construction, or has been laminated, and cut and stacked for application. Another example form of a “tag” is a tag inlay that has been attached to another surface, or between surfaces, such as paper, cardboard, etc., for attachment to an object to be tracked, such as an article of clothing, etc.

Example embodiments of the present invention are described in further detail below. Such embodiments may be implemented in the environments, readers, and tags described above, and/or in alternative environments and alternative RFID devices.

### EXAMPLE EMBODIMENTS

Mobile RFID readers are sometimes operated in unsupervised modes, where human intervention is not available to activate and/or increase scanning frequency or intensity during events of interest (e.g., where a forklift reader picks up a pallet). In these unsupervised modes, the mobile reader typically performs high power scanning. Such high power scanning is undesirable in mobile, battery powered applications. Detection of events of interest can enable mobile RFID readers to intelligently self-adjust the frequency and/or intensity of read attempts, thereby saving significant amounts of power. In battery powered applications, power saved may result in a longer battery life. Methods, systems, and apparatuses for event-based power conservation in an RFID reader are presented. In an embodiment, a mobile reader uses event information to adjust its scanning characteristics or settings.

Scanning may be defined as interrogating all or a portion of all tags in a given location. A location may be scanned multiple times during a pass through of that location. Scanning characteristics of a location may determine the scanning setting used by a reader for one or a series of scans of the location. Power consumed for a given period of scanning is determined at least by the percentage of time scanning (i.e. the duty cycle) and/or the output power during scanning. The frequency of scanning as described herein refers to a number of scans in a time period.

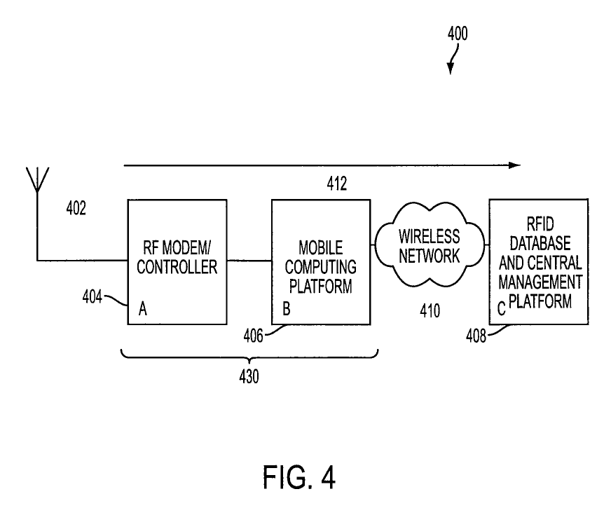

In an embodiment, an ability to infer event information may be implemented in a scanning device, central control device, or any other device within an RFID environment. For example, in FIG. 4 a typical information data path 400 in an RFID system is shown. The RFID system includes an antenna 402, a RF/Modem controller 404, a mobile computing platform 406, an RFID database and central management platform 408, and a wireless network 410. In an embodiment, a reader 430 includes antenna 402, RF/Modem controller, and mobile computing platform 406. Wireless network 410 connects mobile computing platform 406 to RFID database and central management platform 408.

As illustrated by data path 412, data acquired from tags by reader 430 (e.g., unique tag identifiers and received signal strength) is communicated from reader 430 to central management platform 408 via wireless network 410. In fact, event inferring logic may be included in any element within the data path ranging from the reader to the enterprise back-end. In particular, a software module containing event inferring capabilities may be included within RF reader (e.g., in reader firmware), mobile computing platform, and the wireless infrastructure management platform. However, as the event inferring capability is positioned further away from the RF front end, a latency may develop between the occurrence of an event and a corresponding adjustment in scanning settings.

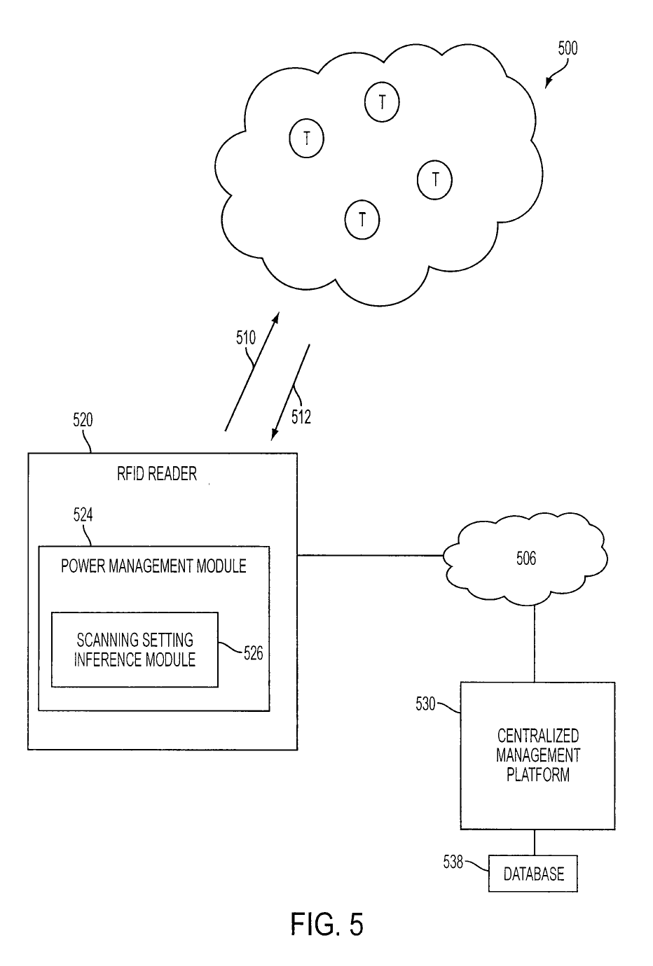

FIG. 5 shows an exemplary system for inferring scanning settings, according to embodiments of the present invention. FIG. 5 includes a population of tags 500, an RFID reader 520, a wireless network 506, and a centralized management platform 530. Reader 520 may be used to track the presence of items in a variety of different environments. For example, reader 520 may be integrated in an inventory device used to track items in a storeroom, a forklift used to track items in a warehouse, or any other applicable device, as would be understood by persons skilled in the relevant art(s). Wireless network 506 may be any type of wireless network including a WiFi wireless network, 802.11 network, or cellular network, as would be understood by persons skilled in the relevant art(s).

Reader 520 includes a power management module 524. Power management module 524 may also include a scanning setting inference module 526. Scanning setting inference module 526 is configured to infer scanning settings based on data received from prior scans or reads of population of tags 500. The scanning settings define the criteria to be used by the reader during a subsequent read of the population after occurrence of the event.

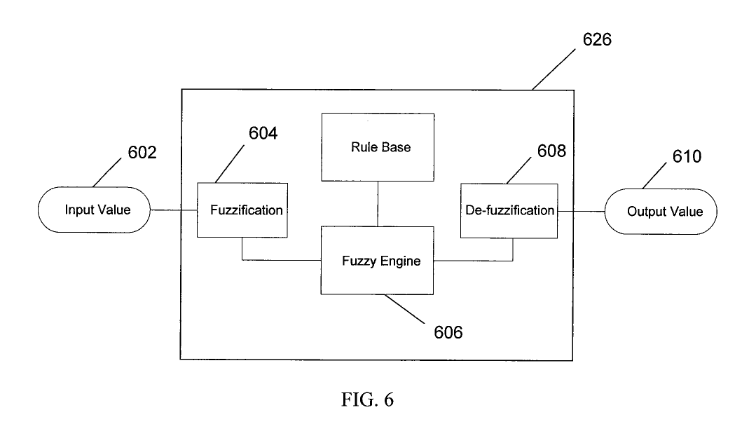

In an embodiment, scanning setting inference module 526 is configured to infer scanning settings through the use of fuzzy logic. FIG. 6 depicts an exemplary scanning setting interface module 626. Scanning setting interface module 626 includes a fuzzification module 604, a fuzzy logic engine 606, and a defuzzification module 608.

Scanning setting interface module 626 receives data from other components of the reader and/or from the centralized platform module. For example, scanning setting inference module 526 may receive information from previous scans. For example, scanning settings inference module 526 may receive identification codes received in response to each scan and a received signal strength indicator (RSSI) value associated each received response (e.g., backscattered response). In a further embodiment, the received data may be used to compute variables. For example, a variable ΔID corresponding to the change in the identification codes received since a previous scan (e.g., the number of identification codes received during a first scan that were not received in a second scan) and a variable ΔRSSI corresponding to the change in an average RSSI value received since a previous scan may be received. Variables ΔID and ΔRSSI may be determined by power management module 524 or other component of reader 520 and/or central management platform 530. Variable ΔID may be normalized by dividing it by the number of tags in population 500 (or another value representing the maximum number of tags that can be scanned at once) and multiplying the quotient by 100. Similarly, variable ΔRSSI may be normalized by subtracting it from the maximum possible RSSI value, dividing the resulting value by the maximum RSSI value, and multiplying quotient by 50.

Fuzzification module performs a fuzzification operation on the received input values. In an embodiment, a fuzzification operation involves computing a membership of the determined variables to different possible states. In an embodiment, different sets or states can be defined “linguistically.” For example, variables ΔID and ΔRSSI may be linguistically defined and have linguistic states. For example, variable ΔID may have states “moving” and “static” and variable ΔRSSI may have states “Rising,” “Steady,” and “Falling.”

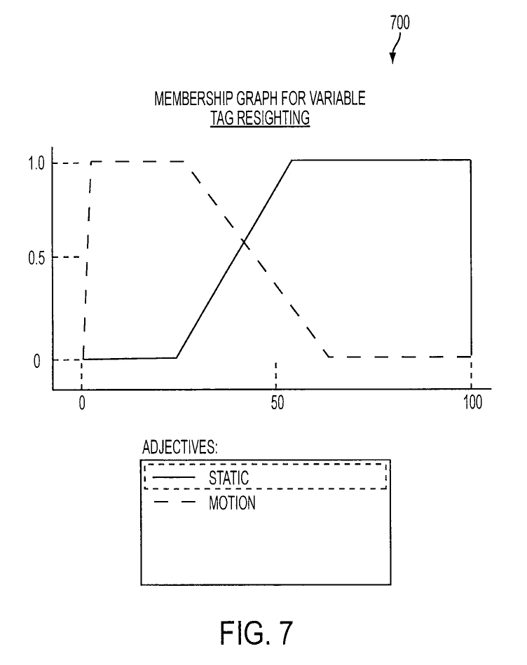

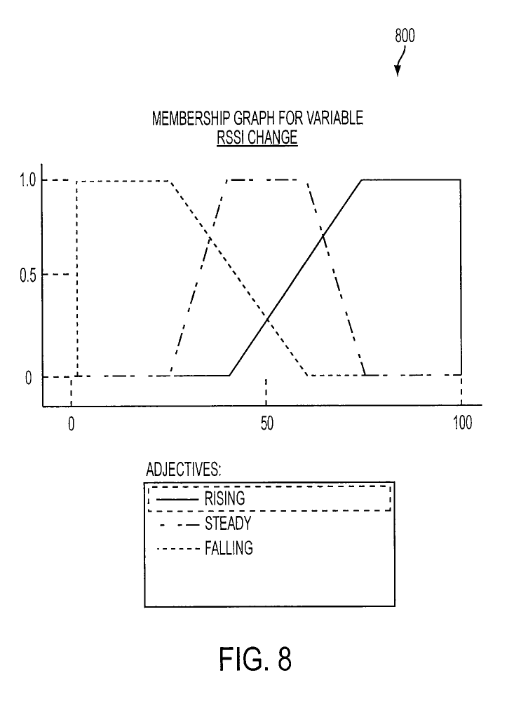

The membership of the variables ΔID and ΔRSSI to each of their possible states is determined by fuzzification module 604. In an embodiment, fuzzification module 604 uses membership function definitions stored in a memory to perform the operation. For example, FIGS. 7 and 8 shows plots 700 and 800, respectively, illustrating an exemplary membership functions for variables ΔID and ΔRSSI, respectively, according to an embodiment of the present invention. The membership function shown in plot 700 maps variable ΔID, normalized as described above, to membership values ranging from 0 to 1 for each of its different possible states. Similarly, the membership function shown in plot 800 maps variable ΔRSSI, normalized as described above, to membership values ranging from 0 to 1 for each of its different possible states

Fuzzy logic engine 606 receives membership values from fuzzification module 604 and a set of rules. Rules may be stored in a memory internal to the reader or external to the reader. Rules may be based on information that is intrinsically gathered during a scanning process. For example, a number of times a tag has been read in period of time or a received signal strength may be used to define rules. Because this information is already available during the tag interrogation process, no additional hardware or software modifications in the interrogation process may be required.

In this manner, users can customize their own “event engines” specific to their applications, installations, and/or business needs. This rule generation feature may be part of a reader software development kit (SDK) and/or centralized RFID/enterprise mobility management platform.

In an embodiment, fuzzy logic engine 606 evaluates a rule set based on the received membership values and maps the results of the rules to strengths of an output state. For example, the results of the rules may have states “Scan fast” and “Scan slow.” State “Scan fast” may correspond to reader 520 scanning at its maximum frequency (e.g., 100% of its maximum frequency) and state “Scan slow” may correspond to the reader 520 not scanning (e.g., 0% of its maximum frequency).

For the purpose of illustration, the rules base may include rules: (1) if ΔID is “static” and ΔRSSI is “Rising” then “Scan fast,” (2) if ΔID is “static” and ΔRSSI is not “Rising” then “Scan slow,” and (3) if ΔID is “moving” and ΔRSSI is “falling” then “Scan fast.” In a further embodiment, each of the rules is event-specific. For example, rule (1) may correspond to a loading event, rule (2) may correspond to no event, and rule (3) may correspond to an unloading event. Thus, scanning may increased when events (e.g., unloading or loading) occur and decreased when no events occur.

In computing output values for the different rules, a logical and operation may be used. For example, if ΔID has a 0.5 membership to the “static” state and ΔRSSI has a 0.4 membership to the state “Rising,” then the output may have a value of 0.4 to the “Scan fast” state. In a further example, rule (2) may have an output value of 0.5 to the “Scan slow” state, and rule (3) may have an output value of 0.3 to the “Scan fast” state. As would be appreciated by those skilled in the relevant art(s), other logical operations may be used to compute outputs of rules.

The outputs of the rules that have the same output state may be combined in root-sum-square method. In such a method, the square root of the sum of the squares of the output of each rule of a set of rules associated with a common output state (e.g., both rules (1) and (3) are associated with the “Scan fast” state) is used to determine the “strength” of each possible output state. For example, the strength of the “Scan fast” state may be determined as the square root of the sum of the squares of the outputs from rules (1) and (3) (e.g., \sqrt{0.4²+0.3²}=0.25) and the strength of the “Scan slow” state may be the output of rule (2) (e.g., 0.4). In alternate embodiments, strengths for each output state may be determined according to other methods, e.g., Max-Min, Max-Product, and averaging.

Defuzzification module 608 performs a defuzzification operation on the output of the fuzzy logic engine 606. For example, defuzzification may be done using the centroid method. In the centroid method, the assigned scanning settings (e.g., scanning frequency or intensity) for each output state are used as the weights to perform a weighted average of the strengths determined by fuzzy logic engine 606. As would be appreciated by those skilled in the relevant art(s) based on the description herein, the centroid method may be analogous to a center of mass calculation with the strengths being the different points and the scan rates being the mass of each point. For example, the centroid for the above described example may be computed as

$$\frac{( 0 \% * 0.4 ) + ( 100 \% * 0.25 )}{0.4 + 0.25} = 38 \% .$$

Thus, the result of the fuzzy logic calculation in the above described invention is to scan at 38% of the fastest possible speed.

As would be apparent to those skilled in the relevant art(s), data that is gathered during interrogations of tags is often intermittent, inconsistent, and not well-defined, due to frequency hopping, interference, or other wireless communication factors. In these types of conditions, fuzzy logic implementations may be better suited to make determinations based on received data. Since membership in fuzzy sets is not strict, relatively minor fluctuations in input data do not change which state a variable is in, but rather changes the membership values for one or more states. Thus, while fluctuations due to unreliable data may result in abrupt transitions between states when using strict membership, such data may result in smooth transitions in membership values for states when allowing for fuzzy membership.

The above example is described with reference to the inference of a scanning frequency. However, as would be apparent to those skilled in the relevant art(s) based on the description herein, scanning setting inference module 626 may also be used to infer other scanning settings (e.g., scanning intensity). As would be appreciated by persons of skill in the art, other techniques to detect the occurrence of events can be used with the present invention.

In an embodiment, information stored at RFID reader 520 that is used to detect the occurrence of event based on measured data may be updated. For example, if RFID reader 520 determines that a distribution of items being monitored has changed, then characteristics of membership functions, rules stored at RFID reader 520, and/or scan frequencies or intensities assigned to different output states may be updated. In an alternate embodiment, updates may be received from centralized management platform 530 via wireless network 506. For example, a user at centralized management platform 530 may store updated rules in database 538. These updated rules may then be communicated to reader 520 by centralized management platform 530 via wireless network 506.

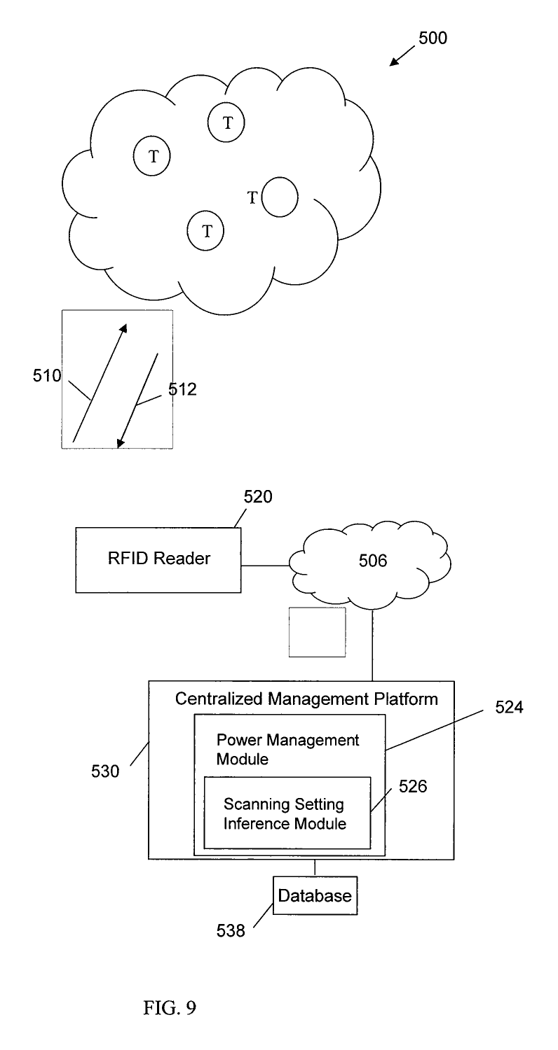

FIG. 9 shows another embodiment of an exemplary system for inferring scanning settings based on past scan data, according to embodiments of the present invention. The embodiment of FIG. 9 is generally similar to the embodiment of FIG. 5. However, in FIG. 9, power management module 524 is located in centralized management platform 530 instead of in reader 520 as shown in FIG. 5.

In FIG. 9, scanning setting inferences are performed by a power management module in the centralized management platform 530 instead of reader 520. In this embodiment, reader 520 may transmit information received from one or more background reads or scans to centralized management platform 530 via wireless network 506. Scanning setting inference module 526 of power management module 524 infers scanning settings based on the received data. For example, scanning setting inference module 526 may perform fuzzy logic operations to infer scanning settings from prior scan data in a manner similar to as described above.

In a further embodiment, characteristics of membership functions, rules, and/or scan frequencies or intensities assigned to different output states may be stored in database 538 and used to update the operation of power management module 524. For example, a user may define a rule set based on a change in the layout of a warehouse.

Power may be saved because of the reduced scanning frequency and/or scanning intensity determined by the inference module. In a further embodiment, reducing the scanning frequency and/or the scanning intensity may also result in improved spectrum management. For example, reducing the scanning frequency of reader 520 may reduce the amount of time reader 520 spends scanning. Furthermore, reducing the scanning frequency and/or scanning intensity also reduces the power with which interrogations may be conducted. Thus, the amount of time reader 520 emits RF radiation in one or more frequency bands and the amount of power emitted by reader 520 into the frequency band(s) may be reduced. The reduction in the amount of time during which RF radiation is emitted and the amount of power emitted may result in a reduced interference with other devices or systems that transmit or receive RF radiation in the frequency band(s).

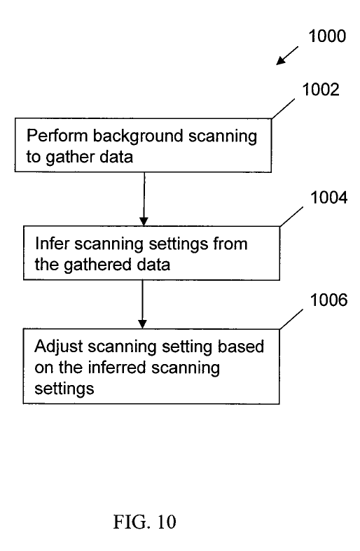

FIG. 10 shows a flowchart 1000 of a method for inferring scanning settings based on prior scan data, according to embodiments of the present invention. The steps shown in FIG. 10 do not necessarily have to occur in the order shown.

In step 1002, background scanning is performed to gather data. The data may include identification codes of one or more tags and/or the received signal strength of a backscattered response from a tag. Additional information can be derived from the scanned data such as the frequency with which a tag is read and the number of tags read during each scan.

In step 1004, scanning settings are inferred from the gathered data. For example, the gathered data may be used as input data to fuzzification module 604 of FIG. 6.

In step 1006, scanning settings are adjusted based on the inferred scanning settings. For example, a scanning frequency and/or a scanning intensity may be adjusted to match the scanning settings inferred in step 1004.

The present invention (i.e., the systems of FIG. 5 or 9 and/or the methods of FIGS. 6 and 10 or any part(s) or function(s) thereof) may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

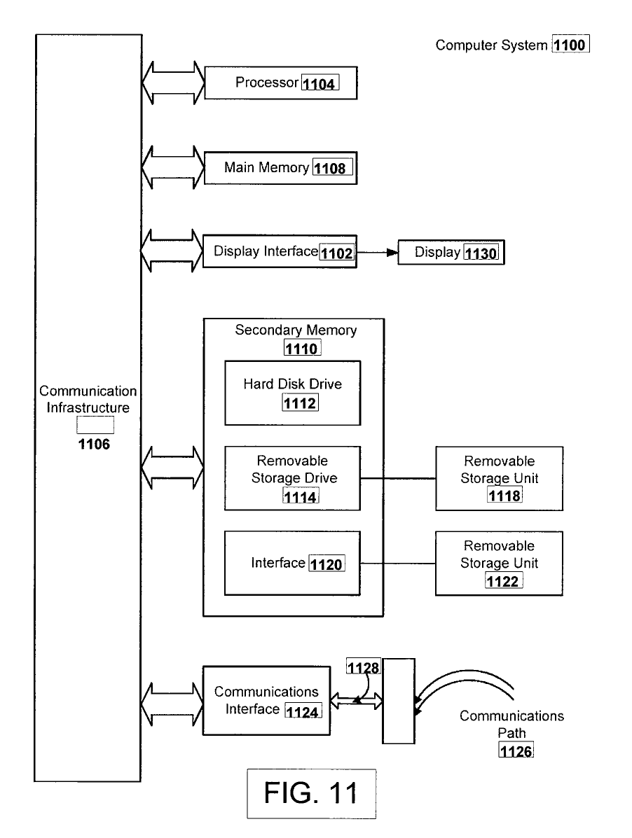

In fact, in one embodiment, the invention is directed toward one or more computer systems capable of carrying out the functionality described herein. An example of a computer system 1100 is shown in FIG. 11.

The computer system 1100 includes one or more processors, such as processor 1104. The processor 1104 is connected to a communication infrastructure 1106 (e.g., a communications bus, cross over bar, or network). Various software embodiments are described in terms of this exemplary computer system. After reading this description, it will become apparent to a person skilled in the relevant art(s) how to implement the invention using other computer systems and/or architectures.

Computer system 1100 can include a display interface 1102 that forwards graphics, text, and other data from the communication infrastructure 1106 (or from a frame buffer not shown) for display on the display unit 1130.

Computer system 1100 also includes a main memory 1108, preferably random access memory (RAM), and may also include a secondary memory 1110. The secondary memory 1110 may include, for example, a hard disk drive 1112 and/or a removable storage drive 1114, representing a floppy disk drive, a magnetic tape drive, an optical disk drive, etc. The removable storage drive 1114 reads from and/or writes to a removable storage unit 1118 in a well known manner. Removable storage unit 1118 represents a floppy disk, magnetic tape, optical disk, etc. which is read by and written to by removable storage drive 1114. As will be appreciated, the removable storage unit 1118 includes a computer usable storage medium having stored therein computer software and/or data.

In alternative embodiments, secondary memory 1110 may include other similar devices for allowing computer programs or other instructions to be loaded into computer system 1100. Such devices may include, for example, a removable storage unit 1122 and an interface 1120. Examples of such may include a program cartridge and cartridge interface (such as that found in video game devices), a removable memory chip (such as an erasable programmable read only memory (EPROM), or programmable read only memory (PROM)) and associated socket, and other removable storage units 1122 and interfaces 1120, which allow software and data to be transferred from the removable storage unit 1122 to computer system 1100.

Computer system 1100 may also include a communications interface 1124. Communications interface 1124 allows software and data to be transferred between computer system 1100 and external devices. Examples of communications interface 1124 may include a modem, a network interface (such as an Ethernet card), a communications port, a Personal Computer Memory Card International Association (PCMCIA) slot and card, etc. Software and data transferred via communications interface 1124 are in the form of signals 1128 which may be electronic, electromagnetic, optical or other signals capable of being received by communications interface 1124. These signals 1128 are provided to communications interface 1124 via a communications path (e.g., channel) 1126. This channel 1126 carries signals 1128 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 1114 and a hard disk installed in hard disk drive 1112. These computer program products provide software to computer system 1100. The invention is directed to such computer program products.

Computer programs (also referred to as computer control logic) are stored in main memory 1108 and/or secondary memory 1110. Computer programs may also be received via communications interface 1124. Such computer programs, when executed, enable the computer system 1100 to perform the features of the present invention, as discussed herein. In particular, the computer programs, when executed, enable the processor 1104 to perform the features of the present invention. Accordingly, such computer programs represent controllers of the computer system 1100.

In an embodiment where the invention is implemented using software, the software may be stored in a computer program product and loaded into computer system 1100 using removable storage drive 1114, hard drive 1112 or communications interface 1124. The control logic (software), when executed by the processor 1104, causes the processor 1104 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A method of managing power consumption in a radio frequency identification (RFID) reader, comprising:
(a) performing a plurality of background scans to gather data associated with a population of RFID tags;
(b) inferring scanning settings based on the gathered data; and
(c) updating scanning settings of the RFID reader based on the inferred scanning settings.

2. The method of claim 1, whereby interference with other readers is reduced.

3. The method of claim 1, step (b) includes:
applying a set of rules to the gathered data, wherein a rule is associated with an event.

4. The method of claim 3, wherein the rules are user-defined.

5. The method of claim 3, wherein step (b) comprises:
determining a membership state using the gathered data; and
evaluating rules based on the determined membership state to produce a plurality of outputs.

6. The method of claim 5, wherein the states are defined linguistically.

7. The method of claim 5, further comprising:
determining a centroid of the plurality of outputs.

8. The method of claim 1, wherein the scanning settings include a frequency of scans.

9. The method of claim 1, wherein the scanning settings include a scanning intensity.

10. A computer program product comprising a computer useable medium including control logic stored therein, said control logic when executed enabling a processor to manage power consumption in a radio frequency identification (RFID) reader, said control logic comprising:
(a) performing means for enabling a processor to perform a plurality of background scans to gather data associated with a population of RFID tags;
(b) inferring means for enabling a processor to infer scanning settings based on the gathered data; and
(c) updating means for enabling a processor to update scanning settings of the RFID reader based on the inferred scanning settings.

11. The computer program product of claim 10, wherein (b) comprises:
applying means for enabling a processor to apply a set of rules to the gathered data, wherein a rule is associated with an event.

12. The computer program product of claim 10, wherein (b) comprises:
determining means for enabling a processor to determine a membership state using the gathered data; and
evaluating means for enabling a processor to evaluate rules based on the membership state to produce a plurality of outputs.

13. The computer program product of claim 12, further comprising:
(d) determining means for enabling a processor to determine a centroid of the plurality of outputs of the rules.

14. The computer program product of claim 10, wherein the scanning settings include at least one of a frequency of scans or a scanning intensity.

15. A mobile radio frequency identification (RFID) reader, comprising:
(a) means for performing a plurality of background scans to gather data associated with a population of RFID tags;
(b) means for inferring scanning settings based on the gathered data; and
(c) means for updating scanning settings of the RFID reader based on the inferred scanning settings.

16. The mobile RFID reader of claim 15, wherein (b) includes:
means for applying a set of rules to the gathered data, wherein a rule is associated with an event.

17. The mobile RFID reader of claim 15, wherein (b) includes:
means for determining membership of the gathered to states; and
means for evaluating rules based on the determined memberships to the states.

18. The mobile RFID reader of claim 17, further comprising:
means for determining a centroid of outputs of the rules.

19. The mobile RFID reader of 15, wherein the scanning settings include at least one of a frequency of scans or a scanning intensity.
